(19) United States
(12) Patent Application Publication
(10) Pub. No.: US 2014/0148249 A1
(43) Pub. Date: May 29, 2014

(54) UTILIZING FRIENDS AS CREDIT IN A GAMING APPLICATION

(71) Applicant: Oliver Michael HAUSLER, Munich (DE)

(72) Inventor: Oliver Michael HAUSLER, Munich (DE)

(21) Appl. No.: 13/834,793

(22) Filed: Mar. 15, 2013

Related U.S. Application Data
(60) Provisional application No. 61/729,945, filed on Nov. 26, 2012.

(51) Int. Cl. G07F 17/32

(52) U.S. Cl. CPC G07F 17/3244
USPC 463/25

(57) ABSTRACT

A novel system and method of performing a game on an electronic device is described. A list of one or more friends is accessed. The list may be accessed from a third-party social networking site. A wager or bet is placed for the electronic game using at least one friend from the list of friends. Next, a user participates in at least one turn of the electronic game. Depending on the outcome for the turn of the electronic game there are two possibilities. In the case of a winning outcome of the electronic game, the at least one friend stays on the list of friends. Otherwise, in the case of a losing outcome of the electronic game, the at least one friend is removed from the list of friends.

### CROSS-REFERENCE TO RELATED APPLICATIONS

The application is a continuation of and claims priority from U.S. Provisional Patent Application No. 61/729,945, filed on Nov. 26, 2012, with inventor Oliver Hausler, the entire disclosure of which is herein incorporated by reference.

### BACKGROUND

1. Field of the Invention

The present invention relates generally to online gaming, and more particularly to friends playing with each other, such as in a social network environment.

2. Description of Related Art

Conventionally, online and mobile games utilize friends retrieved from a social network to foster communication between friends and to have users play against each other. Additionally, because gaming laws often limit or ban utilization of money and/or objects of material value for most players, games utilize play money or credit points to show top-ranking players.

### BRIEF SUMMARY

Provided are a novel system, and computer implemented-method for utilizing social network friends in online or mobile gaming. The methods includes connecting to a third-party social network, retrieving social network friends from the third-party social network, and utilizing friends as credit in a gaming application. The status of each friend may be updated in a database architecture. The status may be displayed in a repository on the screen.

In one example systems include a gaming application configured for utilizing friends from a third-party social network as gaming credit. The gaming application is further configured to use a service development kit to connect to the third-party social network, and a gaming application server with an application program interface. The application program interface is configured for communicating with the gaming application. Further systems include distributed business logic rules and a distributed database architecture. The business logic rules may be configured to determine the logic of the gaming application, and the business logic rules further configured to manipulate the data found in the distributed database.

In one example, a system and method of performing a game on an electronic device is described. The method begins with operating at least one electronic game. The electronic game is any suitable electronic game whether web-based or implemented as a local application or app on a smartphone. The electronic game includes games of chance and/or skill such as but not limited to cards, roulette, bingo, slot, pachinko, dice and lottery. A list of one or more than one of friends is accessed. The list may be accessed from a third-party social networking site. Each of the friends in the list of friends is representing a value. The friends can all have the same value or different values or each friend can have a distinct value. Friends may be identified by a token with a specific color, an icon, a label, a picture of the friend or a combination thereof. A wager or bet is placed for the electronic game using at least one friend from the list of friends. Next, a user participates in at least one turn of the electronic game. The turn can be receiving cards or being dealt card, a spin in roulette, a throwing dice in craps, calling out numbers for bingo or a lottery, and more. Depending on the outcome for the turn of the electronic game there are two possibilities. In the case of a winning outcome of the electronic game, the at least one friend stays on the list of friends. Otherwise, in the case of a losing outcome of the electronic game, the at least one friend is removed from the list of friends. In either the winning or losing outcome, in addition to the list of friends being changed, a virtual coin, a credit, cash, a chip, such as a casino chip, a token, a coupon, may be won or lost as well.

Friends that were previously removed from the list of friends can be re-added to the list of friends in the case of a winning outcome. There are multiple sources of friends. One source of friends is from a third-party social network. Another source of friends is the participants in the electronic game which may or may not be part of the third-party social network. Friends can be exchanged for a virtual coin, credit, cash, a chip, a token, a coupon or a combination thereof. Also friends that are added can be selected based on an association with the participant or user of the electronic game. Examples of associations of friends with the user or participant of the electronic game include a geographic location of the new friend, a gender of the new friend, an interest of the new friend, a relationship with the new friend, or a combination thereof.

### BRIEF DESCRIPTION OF THE SEVERAL VIEWS OF THE DRAWINGS

The accompanying figures where like reference numerals refer to identical or functionally similar elements throughout the separate views, and which together with the detailed description below are incorporated in and form part of the specification, serve to further illustrate various examples and to explain various principles and advantages all in accordance with the present invention, in which:

FIG. 1 is a block diagram of a gaming architecture, showing an electronic game, or gaming application which uses a network to communicate with a gaming application server and a third-party social network.

FIG. 2 is a block diagram of a computer system, showing a processing circuit as used in the gaming application server or in an electronic device on which the gaming application is being played.

FIG. 3 is a screen of a login screen of the gaming application, where the user connects with the third-party social network to begin a user session.

FIGS. 4 through 11 are a series of screens of the user session including an example how friends and chips in a repository of the user may change while the user participates in the gaming application.

FIG. 12 is an illustration which shows how friends may be represented or visualized in the gaming application for FIGS. 4 through 11.

FIG. 13 illustrates three screens of distinct users or participants participating in the gaming application and each participant can see each other, where the distinct users are friends in the third-party social network.

FIGS. 14 and 15 is a flowchart of the program logic employed when the user participates in the gaming application.

FIG. 16 is series of tables, illustrating how database records change while the program logic is employed.

### DETAILED DESCRIPTION

As required, detailed examples of the present invention are disclosed herein; however, it is to be understood that the disclosed examples are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms “a” or “an”, as used herein, are defined as at least one or more than one. The term “plurality”, as used herein, is defined as two, or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically. The terms “program”, “software application”, and the like as used herein, are defined as a sequence of instructions designed for execution on an information processing circuit. A program, computer program, or software application may include a subroutine, a function, a procedure, an object method, an object implementation, an executable application, an applet, a servlet, a source code, an object code, a shared library/dynamic load library and/or other sequence of instructions designed for execution on an information processing circuit. Further, the terms “present application” and “gaming application”, “game” and “electronic game” or “application” and “app” are used interchangeably herein. Also the terms “user” and “participant” are used interchangeably herein. The term “token” means anything that can be traded including casino chips or just chips, virtual currency, currency, coupons, vouchers, currency slips, and equivalents. Further, the database terms “record” and “row” are used interchangeably herein.

### Gaming Architecture

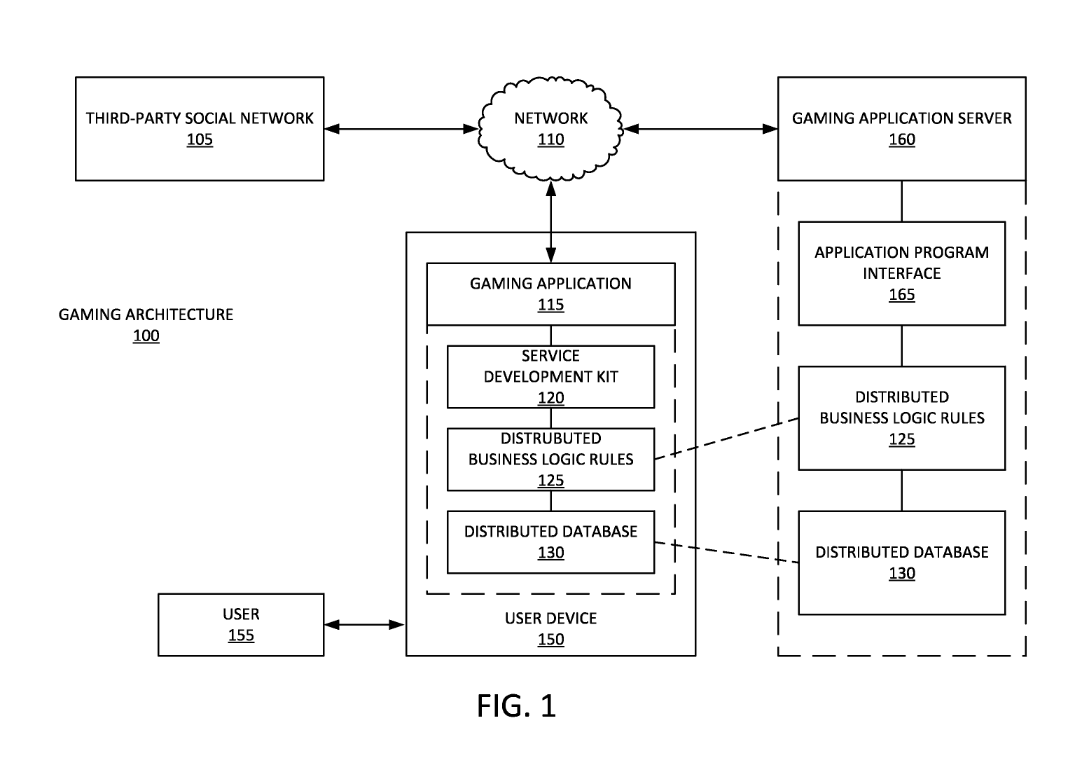

Turning now to FIG. 1, shown is a block diagram of an example of a gaming architecture 100. The gaming architecture may include a third-party social network 105, a network 110, a gaming application 115 and a gaming application server 160. The gaming application server 160 may include at least one of an application program interface 165, a distributed business logic rules 125 and a distributed database 130. The gaming application 115 may include at least one of a service development kit (“SDK”) 120, a segment of the distributed business logic rules 125 and a segment of the distributed database 130. The gaming architecture may further include a user device 150, where the gaming application 115 is executed on the user device 150 and the user device 150 is utilized by a user 155.

In various examples, at least one of the service development kit 120, the distributed business logic rules 125 and the distributed database 130 may form part of the gaming application 115, which may be executed on the user device 150. The network 110 may represent any network where the transmission of digital content occurs, including the internet.

In one example, at least one of the distributed business logic rules 125 and the distributed database 130 is segmented across at least one of the gaming application server 160 and at least one of the user device 150, and information stored in the distributed database 130 either resides redundantly on a plurality of segments, or each segment contains only a subset of the information.

In another example, no service development kit 120 is used, or the gaming application 115 is executed directly within the third-party social network 105.

According to various examples, the gaming application 115 may be a program which utilizes information found in a database such as the distributed database 130. The gaming application 115 may communicate with the gaming application server 160 over the network 110 and utilize the application program interface 165 to access information stored in the distributed database 130 on the gaming application server 160.

In one example, the distributed database 130 may be comprised of multiple databases and the number of databases may increase or decrease over time. The distributed business logic rules 125 and the distributed database 130 may be partially implemented into the user device 150 and/or the gaming application server 160 and the database 130 may pool some or all of the data found in distributed database 130. The data found in the distributed database 130 may represent some or all of the data retrieved from the third-party social network 105.

In one example the application programming interface 165 is a web service that may provide the gaming application 115 access to some or all of the information found in the distributed database 130 segment on the gaming application server 160.

In one further example the gaming application 115 may be developed in any programming environment typically used for creating dynamic webpages and/or applications, including, however not limited to, XCode, Visual Studio, PhoneGap and Eclipse, with syntax from at least one of, however not limited to, HTML, XML, PHP, Java, JavaScript, C, C++, C#, Objective-C, and Visual Basic.

The electronic device or user device 150, according to one example, may be most any computing or digital data processing device, which is capable of establishing a connection with the network 110. Examples may include desktop computers, laptop computers, and/or certain mobile devices, such as cell phones, smart phones, tablets, slate computers or personal digital assistants (“PDAs”), game consoles, digital cameras, computers or processors in cars, boats or airplanes (e.g. navigation devices), stereo receivers, radios or networkable picture frames, etc. The gaming application 115 may reside on a server internal or external to the third-party social network 105. The gaming application 115 may also be a desktop software application, a widget, a software application for a mobile device such as a phone, a tablet or a “Personal Digital Assistant” (PDA), and/or an application for another computing device or digital data processor that is at least partially capable of establishing a network connection with the network 110. Further, the computing device or digital data processor may or may not have an internet browser, such as “Microsoft Internet Explorer” for network connectivity. For example, the gaming application 115 may be a software tool that resides on or works with a game console, digital camera, cell phone or networkable picture frame (all of which may lack an internet browser) with a connection to a network 110 that may communicate with the third party social network 105.

The gaming application server 160, according to various examples, may employ most any server application developed in any programming environment typically used for creating server applications, including, however not limited to, XCode, Visual Studio, and Eclipse, with syntax from at least one of, however not limited to, HTML, XML, PHP, Java, C, C++, C#, Objective-C, and Visual Basic.

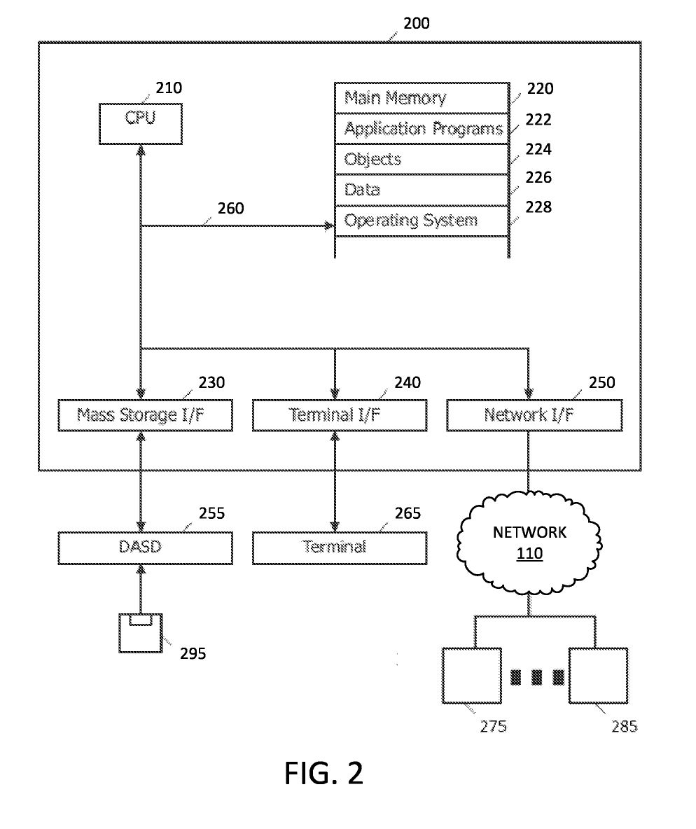

The gaming application server 160, according to various examples, may be hosted on most any computing or digital processing device, which is capable of establishing a connection with network 110, such as for example computer system 200 (FIG. 2). Further examples may include server computers, desktop computers, network attached storage devices, etc. The gaming application server 160, in another example, may also be hosted on a virtual machine or in the cloud, utilizing a cloud hosting service such as Amazon AWS, Amazon EC2, Windows Azure, Rackspace Cloud or other.

In a further example, the service development kit 120 may be part of the third-party social network 105 and may be accessed by the gaming application 115 over the network 110 by utilizing technologies including, however not limited to, Web Services, SOAP, REST and AJAX.

In another example, the gaming application 115 may be hosted on the gaming application server 160 and may be accessed remotely by the user device 150 over remote access protocols typically used for accessing applications remotely, such as, but not limited to, RDP, vnc, ARD, ICA, X11, ALP, ssh, and Telnet. In one example, the service development kit 120 may be located on the gaming application server 160 and the third-party social network 105 may be accessed directly by the gaming application server 160.

In various examples, the third-party social network 105 may be at least one of a social network such as, however not limited to, Facebook, Twitter, Google+, Windows Live, Instagram and Pinterest. The service development kit 120 may be provided by the third-party social network 105 and is utilized by the gaming application 115 to connect to and communicate with the third-party social network 105.

In one example the user 155 is member of the third-party social network 105 and the gaming application 115 may retrieve profiles, photos, friends and/or relevant events on behalf of the user 155, which it may store in the distributed database 130.

In one further example, the optional business logic rules 125 may define what information is requested from the third-party social network 105 and how the information is used in the gaming application 115.

In another example, the gaming application 115 may be at least one of, but not limited to, a simulated casino game, a card game, a poker game, a competition, or any kind of application which makes use of friends as credit.

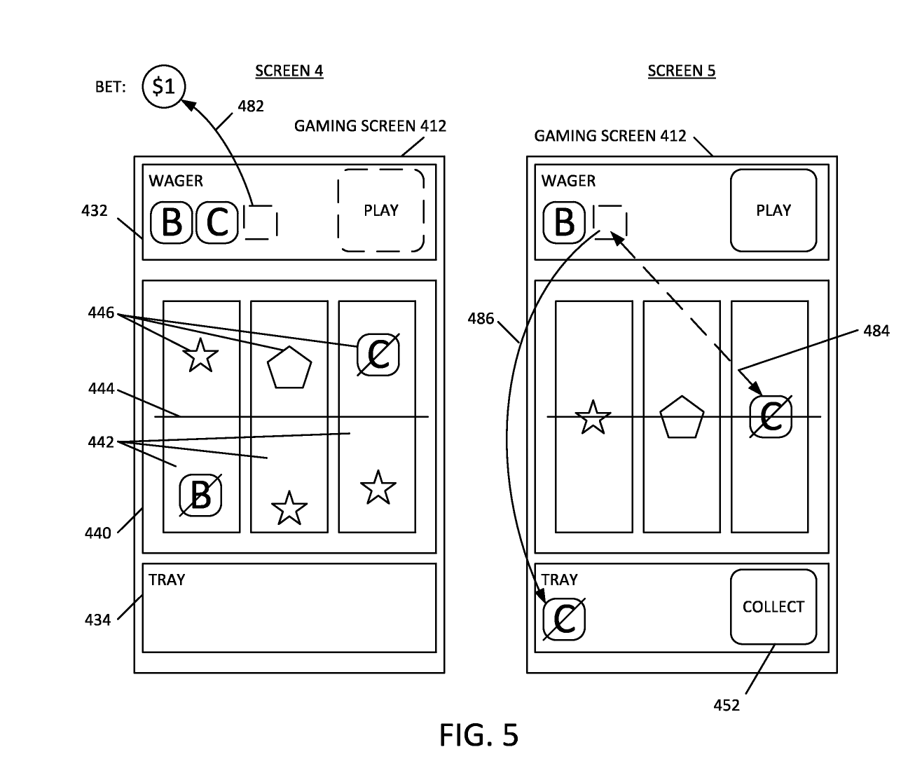

In another example, the optional business logic rules 125 determine which games are provided as electronic game 440, as shown in FIG. 5, to the user 155.

### Computer System

FIG. 2 is a block diagram of a computer system 200, which is a processing circuit as used by one example of the present invention. The computer system 200 may be used in at least one of the gaming application server 160 (FIG. 1) and the user device 150 (FIG. 1).

Processing circuits as understood in this specification include a broad range of processors, including any variety of processing circuit or computer system that is located at a single location, or distributed over several identifiable processors. These several processors are further able to be collocated or physically dispersed within a local area or a geographically widespread area. Any suitably configured processing system is also able to be used by examples of the present invention. The computer system 200 has a processor (“CPU”) 210 that is connected to a main memory 220, a mass storage interface 230, a terminal interface 240 and a network interface 250. A system bus 260 interconnects these system components. The mass storage interface 230 is used to connect mass storage devices, such as the direct access storage device (“DASD”) device 255, to the computer system 200. One specific type of DASD device is a floppy disk drive, which may be used to store data to and read data from a DVD, CD or other non-transitory computer readable storage medium such as a floppy diskette 295.

The main memory 220 contains application programs 222, objects 224, data 226 and an operating system 228. Although illustrated as concurrently resident in the main memory 220, it is clear that the application programs 222, objects 224, data 226 and the operating system 228 are not required to be completely resident in the main memory 220 at all times or even at the same time. Computer system 200 utilizes conventional virtual addressing mechanisms to allow programs to behave as if they have access to a large, single storage entity, referred to herein as a computer system memory, instead of access to multiple, smaller storage entities such as the main memory 220 and the DASD device 255. Note that the term “computer system memory” is used herein to generically refer to the entire virtual memory of the computer system 200.

The operating system 228 is a suitable multitasking operating system. The operating system 228 includes a DASD management user interface program to manage access through the mass storage interface 230. Examples of the present invention utilize architectures, such as an object oriented framework mechanism, that allows instructions of the components of the operating system 228 to be executed on any processor within the computer system 200.

Although only one CPU 210 is illustrated for the computer system 200, computer systems with multiple CPUs can be used equally effectively. Examples of the present invention incorporate interfaces that each includes separate, fully programmed microprocessors that are used to off-load processing from the CPU 210. A terminal interface 240 is used to directly connect one or more than one of terminals 265 to the computer system 200. These terminals 265, which are able to be non-intelligent or fully programmable workstations, are used to allow the system administrators and users to communicate with the computer system 200. Instead of terminals 265, other input devices may be used, such as, but not limited to, a keyboard, a mouse, a touchscreen or a touchpad. Input devices or terminals 265 may also be connected remotely by using the network 110 and the network interface 250.

The network interface 250 is used to connect other computer systems, group members or networks, such as for example stations 275 and 285, to the computer system 200. The present invention works with any data communications connections including present day analog and/or digital techniques, wireless networks, or via a future networking mechanism. Stations 275 and 285 may be connected to the network interface 250 directly or by using the network 110 (FIG. 1). Although only one network interface 250 is illustrated for the computer system 200, computer systems with multiple network interfaces can be used equally effectively.

Although one examples of the present invention are described in the context of a fully functional computer system, those skilled in the art will appreciate that examples are capable of being distributed as a program product via floppy disk, e.g. floppy disk 295, CD, DVD, SD card, hard disks, hard disk arrays, or other form of recordable media, or via any type of electronic transmission mechanism.

### Logon Screen

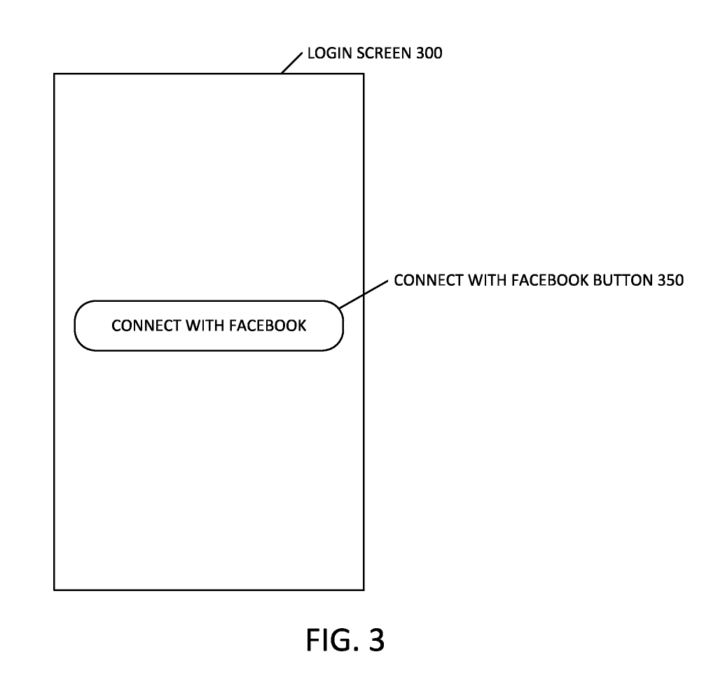

FIG. 3 is a screen of one example of a login screen 300 of the gaming application 115 (FIG. 1), where the user 155 (FIG. 1) connects with the third-party social network 105 (FIG. 1) to begin a user session. The screen shows an example of a procedure that may be employed by the user 155 (FIG. 1) on a device such as the user device 150 (FIG. 1). According to one example, the user 155 (FIG. 1) who desires to play the gaming application 115 (FIG. 1) may invoke a “Connect with Facebook” button 350 within the login screen 300 of the gaming application 115 (FIG. 1). The gaming application 115 (FIG. 1) may then connect to the third-party social network 105 (FIG. 1) in the context of the user 155 (FIG. 1).

According to another example, the gaming application 115 (FIG. 1) may connect to the third-party social network 105 (FIG. 1) silently and without showing the login screen 300.

In one further example, the gaming application 115 (FIG. 1) may connect to the third-party social network 105 (FIG. 1) after showing a dialog window to the user 155 (FIG. 1) and the dialog window may be invoked by the underlying operating system of the user device 150 (FIG. 1). Where the gaming application 115 (FIG. 1) is executed within an internet browser, the dialog window may also be a frame, an area or a division such as, but not limited to, an iframe, a span element or a div element, which connects to and communicates with the third-party social network 105 (FIG. 1) by using a programming language such as, but not limited to, HTML and JavaScript. Often, content within the frame is provided by the third-party social network 105 (FIG. 1).

Upon selection of a connection request to the third-party social network 105 (FIG. 1), the third-party social network 105 (FIG. 1) may approve the connection of the gaming application 115 (FIG. 1) on behalf of the user 155 (FIG. 1), and the gaming application 115 (FIG. 1) may utilize resources of the third-party social network 105 (FIG. 1), such as, but not limited to, the profile, photos and friends of the user 155 (FIG. 1).

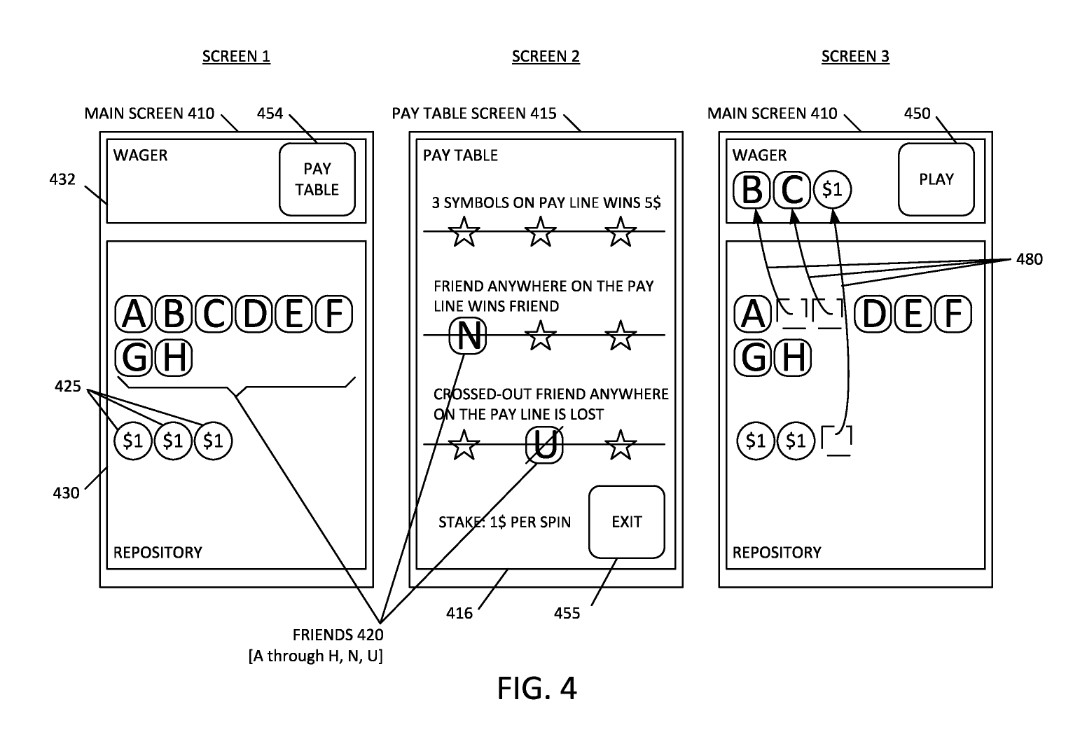

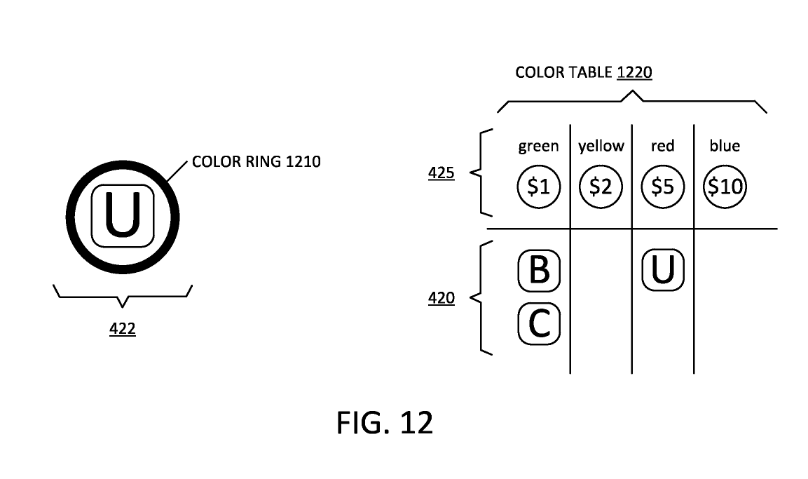

In one example, the friends from the list of friends 420, as shown in FIG. 4, are retrieved from the third-party social network 105 (FIG. 1), together with their profile photo, and the profile photo is shown in a distinct frame or with an overlay. For example each photo of a friend may be shown in the center of a chip or surrounded by a color ring 1210, as depicted in FIG. 12.

In one example, the gaming application 115 (FIG. 1) may synchronize the list of friends 420 (FIG. 4), with the third-party social network 105 (FIG. 1) in regular intervals. In another example, the list of friends 420 (FIG. 4) is synchronized as determined by the distributed business logic rules 125 (FIG. 1) or the gaming application 115 (FIG. 1).

In a further example, the gaming application 115 (FIG. 1) may be offline between synchronizations with the third-party social network 105 (FIG. 1), and no network connection with the network 110 (FIG. 1) is required between synchronizations.

Examples of how to connect to a third-party social network are described in U.S. Pat. No. 8,136,145, Fetterman et al, Facebook and further explained at online URL (http://developers.facebook.com/docs/howtos/login-with-facebook-using-ios-sdk) the teachings of which are hereby incorporated by reference hereinto in its entirety. Shown is how the gaming application 115 (FIG. 1) may connect to and make use of the Facebook third-party social network. The third-party social network 105 (FIG. 1) can be any third-party social network, such as, but not limited to, Facebook, Twitter, Google+, Windows Live, Instagram and Pinterest, and the gaming application 115 (FIG. 1) may connect to a plurality of third-party social networks simultaneously.

### Screen Shots of Turns or Rounds of Play

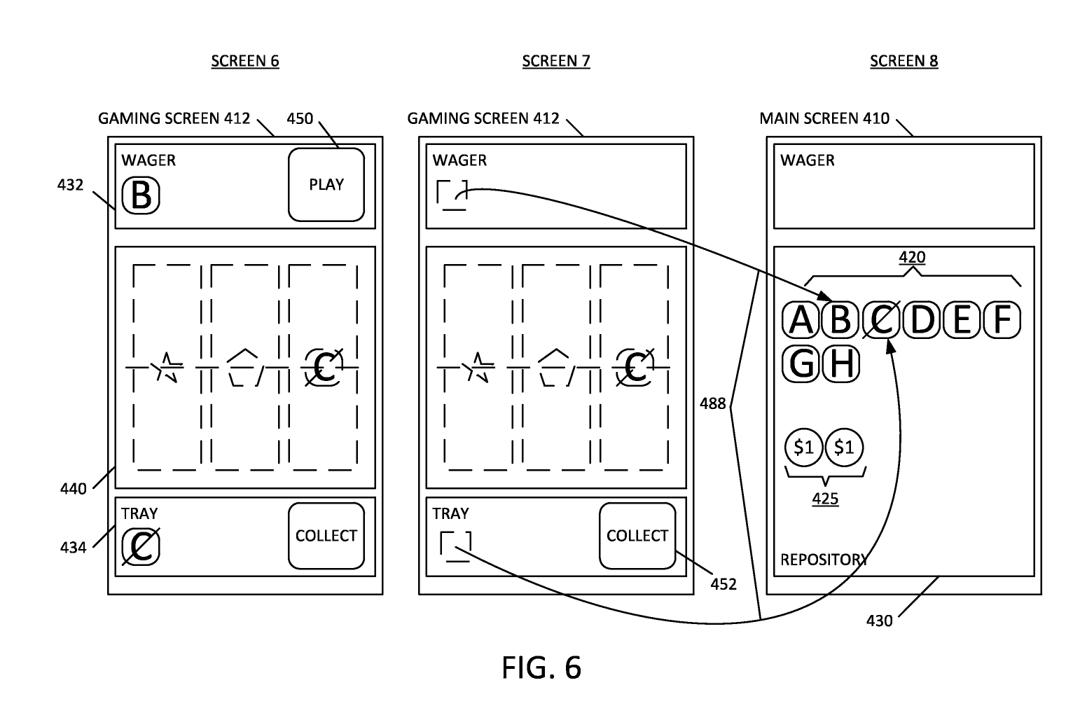

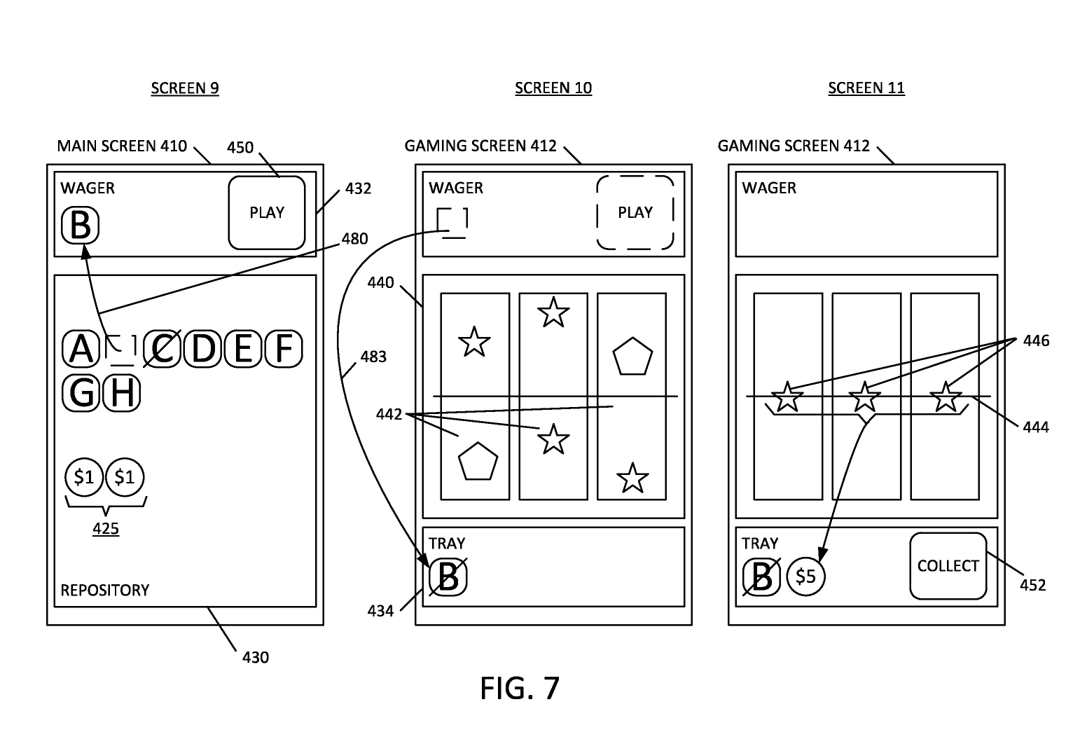

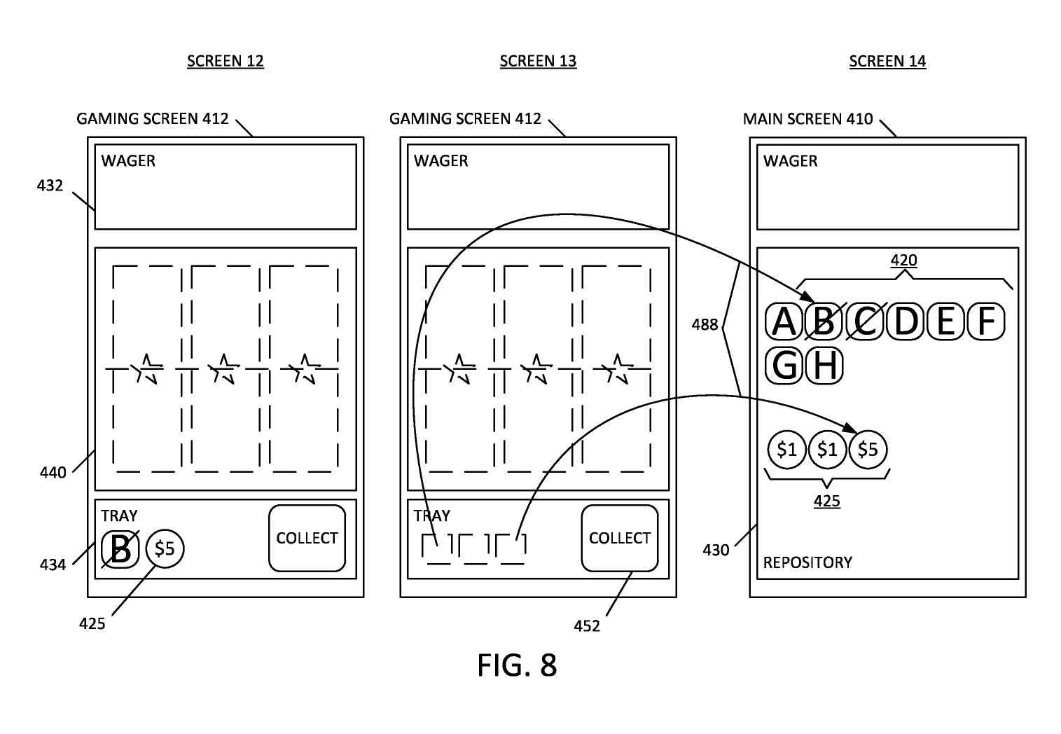

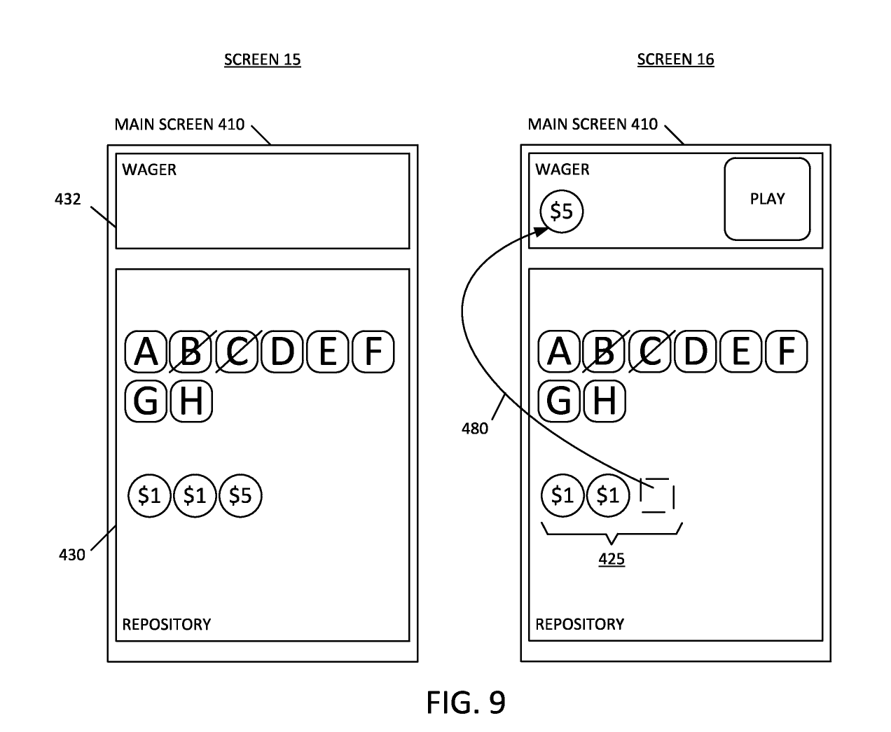

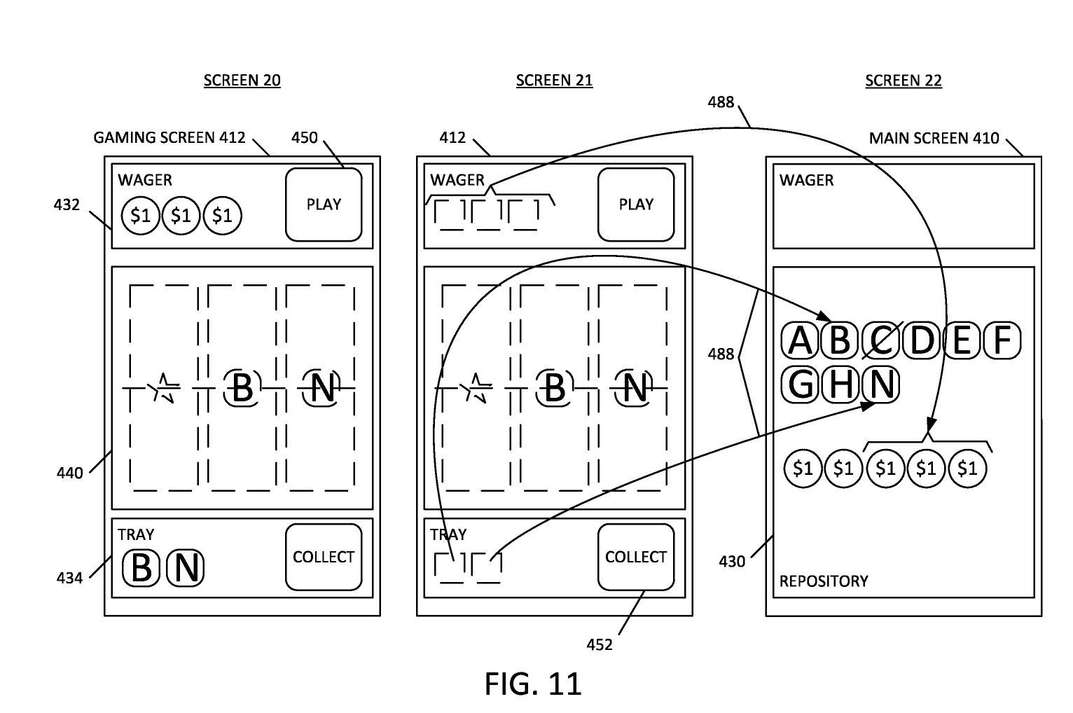

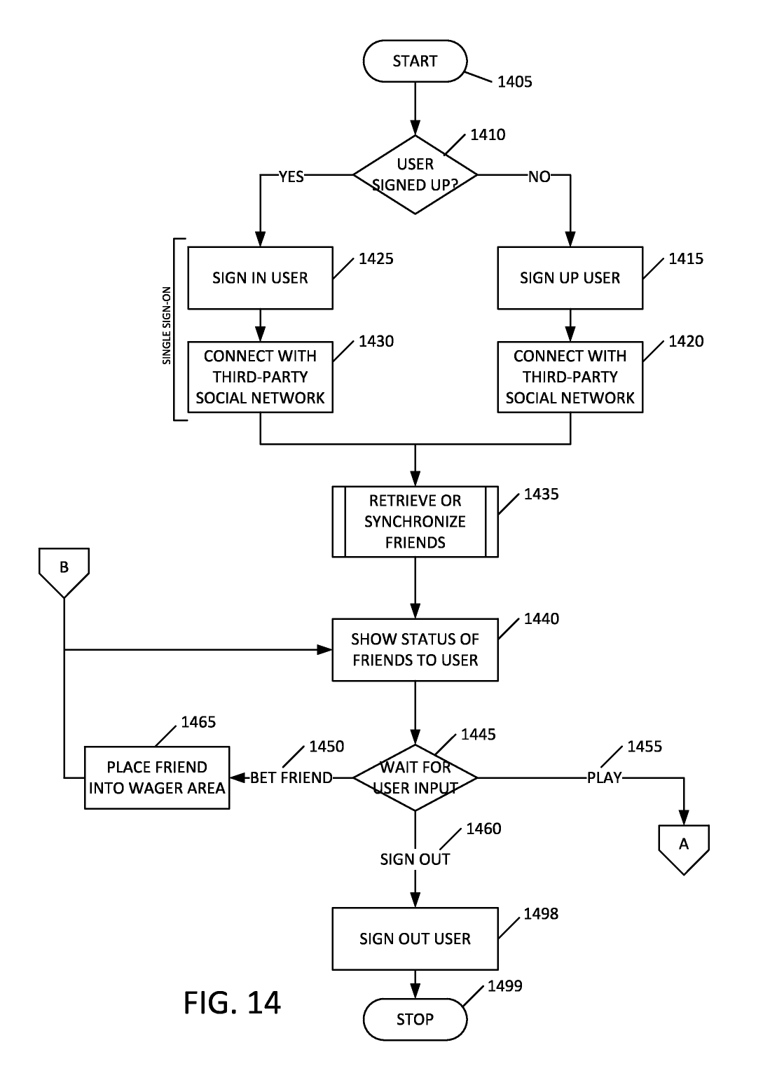

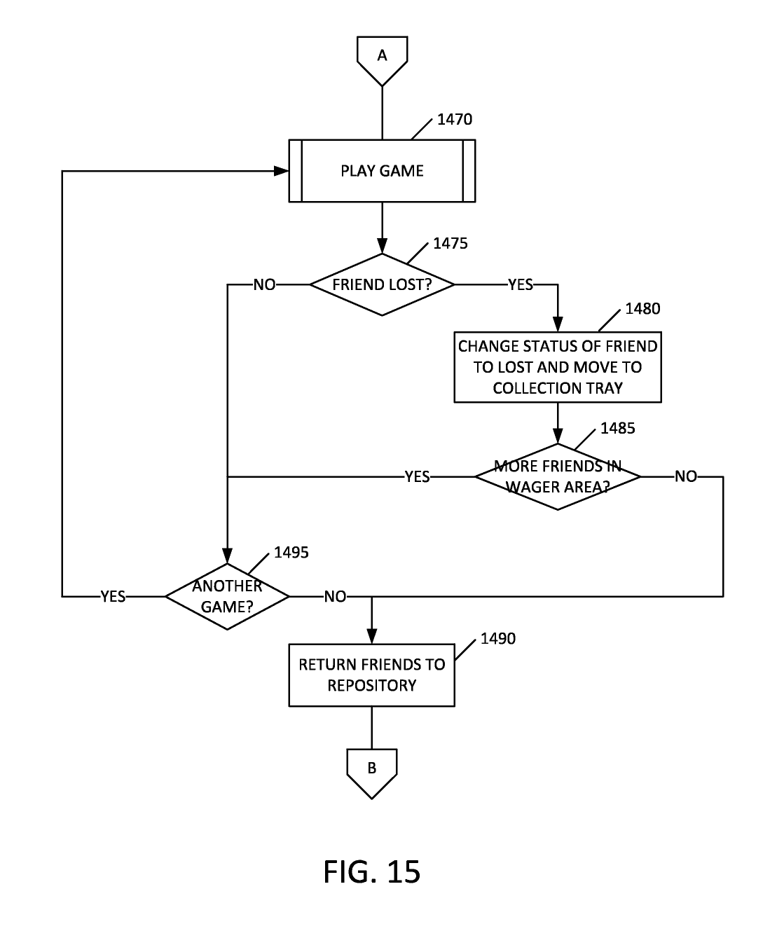

FIGS. 4 through 11 are screens of the user session, after the user 155 (FIG. 1) successfully connects with the third-party social network 105 (FIG. 1), as shown in FIG. 3. Examples of consecutive screens screen 1 through screen 22 are shown, as the user 155 (FIG. 1) invokes the gaming application 115 (FIG. 1) and the program logic of the gaming application 115 (FIG. 1) is applied, as shown in FIGS. 14 and 15. It is important to note, that there are multiple sources of friends. One source of friends is from a third-party social network. Another source of friends is the participants in the electronic game which may or may not be part of the third-party social network.

Screen 1 shows a screen of a main screen 410, according to one example, where a repository 430 and a wager area 432 are shown to the user 155 (FIG. 1). The repository 430 displays a list of friends 420 [labeled with capital letters A through H, N and U] of the user 155 (FIG. 1), which have been retrieved from or synchronized with the third-party social network 105 (FIG. 1), or which the user 155 (FIG. 1) may have won during previous play of the gaming application 115 (FIG. 1). It also displays the status of each friend from the list of friends 420, which can be either active or lost. In the screens, each friend from the list of friends 420 is illustrated as a box with rounded edges and a capital letter A through H, N or U in the center of the box. Each friend from the list of friends 420 may either be shown as active or as lost, where a lost friend is depicted as a crossed-out box, as shown for the friend U in screen 2 and for the friend C in screen 8. In one example, friends of the third-party social network 105 (FIG. 1) are initially active and may be lost during the selection of the electronic game, as shown in screen 4 through screen 8.

In another example, a friend from the list of friends 420 may already appear with the status lost, after the user 155 (FIG. 1) successfully connects with the third-party social network 105 (FIG. 1), for example, when the user 155 (FIG. 1) has lost at least one of social network friends from the list of friends 420 during previous play of the gaming application 115 (FIG. 1).

In one example, the repository 430 further displays the amount of chips 425, which the user 155 (FIG. 1) owns as virtual currency in the gaming application 115 (FIG. 1). The user 155 (FIG. 1) may win a chip of the chips 425 during the selection of the electronic game 440 (FIG. 5), as shown in screen 9 through screen 11. The status of the list of friends 420 and the chips 425 in the repository 430 is persisted to the distributed database 130 (FIG. 1) when changes occur in the repository 430, and restored upon consecutive selection of the gaming application 115 (FIG. 1). In one example, as shown in screen 1, the user 155 (FIG. 1) owns a total amount of $3 in chips 425, and has eight active friends A through H.

After the gaming application 115 (FIG. 1) initially connects with the third-party social network 105 (FIG. 1), the wager area 432 shows no content, but a pay table button 454 may be shown, which the user 155 (FIG. 1) may invoke to look up the pay table, as shown in screen 2.

In screen 1 through screen 22, the pay table button 454, the exit button 455, the play button 450 and the collect button 452 (FIG. 5) are shown in bold, whenever the selection of any of these buttons, according to the examples shown, leads the user 155 (FIG. 1) to the next screen of screen 1 through screen 22. For example, in screen 1, the pay table button 454 is depicted in bold, because the selection of the pay table button 454 leads the user to screen 2, the next screen shown in the example.

Screen 2 shows a screen of a pay table screen 415, where a pay table 416 with gaming rules is shown to the user 155 (FIG. 1), after the user invokes the pay table button 454.

The gaming application 115 (FIG. 1) may include one or more than one of games, each of which may have different rules and different screen layouts, such as, but not limited to, a slot machine, a wheel of fortune, a roulette game, a poker game, a blackjack game, etc. According to one example, the gaming application 115 (FIG. 1) simulates a 3-wheel slot machine, where a spin of virtual wheels is invoked during the game and the user 155 (FIG. 1) may lose or win according to the pay table 416. Each game may consist of a plurality of turns, as shown in screen 16 through screen 19.

As commonly known, a 3-wheel slot machine requires the user to bet coins, tokens or chips. When the game is invoked, the wheels start spinning for a few seconds. When the wheels stop, symbols appear on the pay line, and the user may win according to the pay table, when certain symbols or combinations of symbols appear on the pay line.

In one example, as shown by the pay table 416, the user 155 (FIG. 1) must bet at least one of a chip of the chips 425 and a friend from the list of friends 420, with a total value equivalent to $1 to invoke one spin or turn in the electronic game. The user 155 (FIG. 1) may decide to bet more than $1 as to receive multiple spins. During each spin, the user 155 (FIG. 1) may either win nothing; or the user 155 (FIG. 1) may win or lose according to the pay table 416. Although not perfectly suitable for this example as the user may also lose, the term pay table has been adapted from physical slot machines. As the pay table 416 in one example shows, the user may win chips 425 of a total value equivalent to $5 if three of the same symbols appear on the pay line. Further, the user may win or lose a friend, if a single symbol representing the friend appears anywhere on the pay line 444, as shown in screen 4. As shown for the friend N in pay table 416, the user wins the friend when it appears on the pay line 444 as active friend. As shown for the friend U in pay table 416, the user loses the friend when it appears on the pay line 444 as lost friend.

In one example, the pay table 416 also includes an exit button 455, which the user 155 (FIG. 1) may invoke to close the pay table 416 and return to the main screen 410.

Screen 3 shows the screen of the main screen 410 again, where the user 155 (FIG. 1) may select 480 an active friend from the list of friends 420, a chip, or combination thereof, by moving it into the wager area 432. The user cannot move lost friends into the wager area 432. The sum of the face values of all chips 425 and the value of the selected friends, determines the amount of spins the user 155 (FIG. 1) may play. If the sum of all stake items in the wager area 432 is at least $1, a play button 450 is shown in the wager area 432.

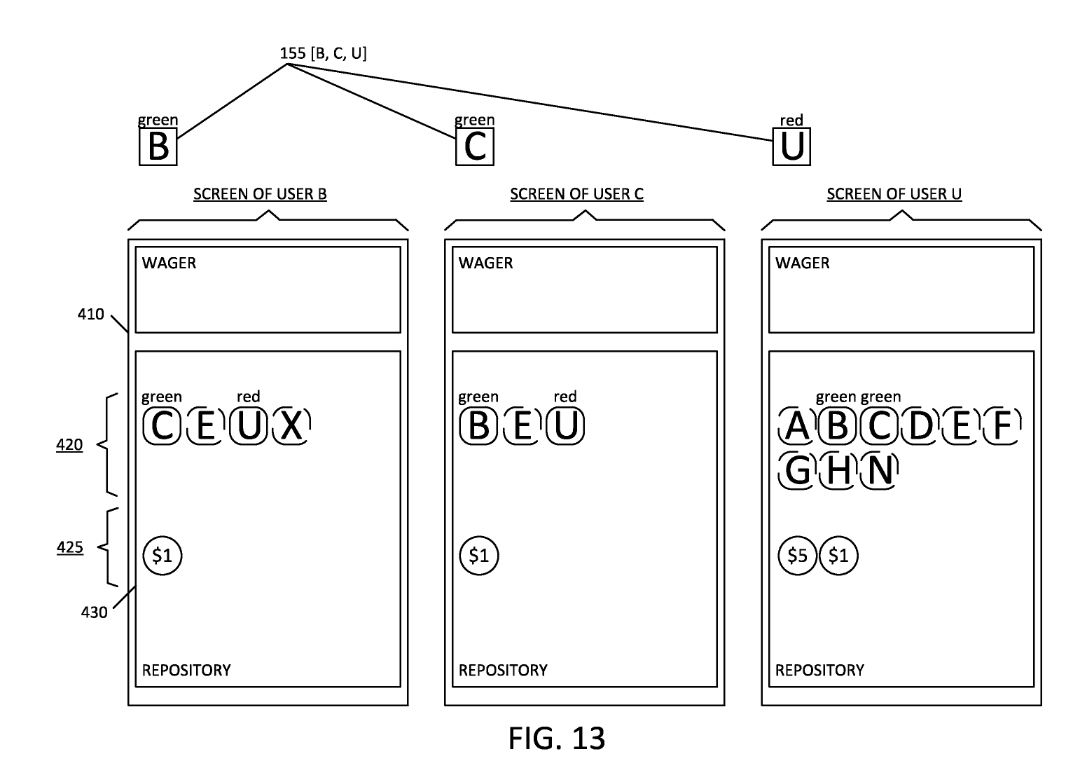

According to one example, the value of a friend from the list of friends 420 is determined by looking at the repository 430 of the user associated with the friend, and by calculating the sum of all chips 425 contained therein, as further explained in FIG. 13.

In one example, the user 155 (FIG. 1) may move 480 the active friends B and C, as well as one $1 in chips 425 into the wager area 432, which add up to a total value of $3, giving the user 155 (FIG. 1) three spins. The user 155 (FIG. 1) may then invoke the play button 450 to start the first spin.

Screen 4 shows a screen of a gaming screen 412, after the user 155 (FIG. 1) has invoked the play button 450 (FIG. 4). The gaming screen 412 shows the same wager area of main screen 410 (FIG. 4), but a game 440 and a collection tray 434 are shown instead of the repository 430 (FIG. 4).

The game 440 may be any kind of game, such as, but not limited to, a slot machine, a wheel of fortune, a roulette game, a poker game, a blackjack game, etc. According to one example, the game 440 is a simulated 3-wheel slot machine, which may show a pay line 444 and three virtual wheels 442 within the gaming area of game 440, with each of the virtual wheels 442 portraying a plurality of symbols 446. The symbols 446 may either be arbitrary symbols as they are habitually used in slot machines, where the meaning of each symbol is explained in the pay table 416 (FIG. 4); or each of the symbols 446 may represent a friend, where the friend may be a friend from the list of friends 420 (FIG. 4), or a user of the gaming application 115 (FIG. 1). When the virtual wheels 442 start spinning, as shown in screen 4, the symbols 446 circulate on the virtual wheels 442.

Initially, when a new game 440 is started, the collection tray 434 contains nothing. As depicted in screen 5, screen 11 and screen 19, the collection tray 434 may show at least one of either a chip of the chips 425 (FIG. 4) and a friend from the list of friends 420 (FIG. 4) after the game 440 is invoked by the user 155 (FIG. 1), which are added to the collection tray as these are won or lost during each spin of the game 440.

In one example, when the user 155 (FIG. 1) invokes the play button 450 (FIG. 4) in main screen 410 (FIG. 4), as shown in screen 3, the gaming screen 412 is shown and the gaming application 115 (FIG. 1) starts the first spin of the game 440. The value of $1, as the equivalent value to the bet price of a spin, according to the pay table 416, is taken out 482 of the wager area 432. In one example, chips 425 (FIG. 4) are taken from the wager area 432 first, if the wager area 432 contains both of a chip of the chips 425 (FIG. 4) and a friend from the list of friends 420 (FIG. 4). In another example, stake items may be taken out of the wager area 432 with a different preference, such as, for example, stake items being taken out in the same order as they have been placed into the wager area 432.

In the game 440, the virtual wheels 442 stop spinning after a random amount of time and reveal the outcome of the game.

Screen 5 shows a screen of the gaming screen 412, after the virtual wheels 442 have stopped spinning and the symbols 446 appear on the pay line 444. The outcome of the spin is determined, according to the pay table 416 (FIG. 4). In one example, the friend C appears as lost friend on at least one of the virtual wheels 442, which entails 484 that the user 155 (FIG. 1) has lost the friend C during the spin. In turn, the status of the friend C is changed from active to lost, and the friend C is moved 486 from the wager area 432 to the collection tray 434, the result being shown in screen 6.

After the first spin in each game 440, a collect button 452 is shown in the collection tray 434, and results from multiple spins are accumulated in the collection tray 434, until the user 155 (FIG. 1) invokes the collect button 452.

Screen 6 shows a screen of the gaming screen 412, which depicts the final status of items in the wager area 432 and the collection tray 434, after the outcome of the previous spin has been processed. The lost friend C is shown in the collection tray 434, and the wager area 432 still contains the active friend B.

According to the program logic, as shown in FIGS. 14 and 15, after each spin, the user 155 (FIG. 1) may either decide to start another spin by invoking the play button 450, or the user 155 (FIG. 1) may decide to collect all items from the collection tray 434, as well as all stake items not used during the game 440 (FIG. 5) from the wager area 432, which are then returned 488 to the repository as shown in screen 8.

Screen 7 and screen 8 show two consecutive screens, where the user 155 (FIG. 1) invokes the collect button 452 in gaming screen 412, as shown in screen 7. The game 440 (FIG. 5) is ended and the repository 430 is updated 488, before the main screen 410 is displayed again, as shown in screen 8. During the update of the repository 430, friend B, which has not been utilized during the previous game, is returned from the wager area 432 to the repository 430, and the status of friend C, which has been lost during the previous game 440 (FIG. 5), is updated in the repository 430. Further, the reduced amount of chips 425 is reflected in the repository 430, as $1 has been bet, as shown in screen 4. In screen 8, the user 155 (FIG. 1) owns a total amount of $2 in chips 425 and has eight friends A through H, where all friends from the list of friends 420 except the friend C are active friends, and where the friend C is lost.

Again, the list of friends 420 and the chips 425 in the repository 430 is persisted to the distributed database 130 (FIG. 1), after the repository 430 has been updated.

Screen 9 shows another screen of the main screen 410. In one example, the user 155 (FIG. 1) may move 480 the active friend B into the wager area 432, which allows the user 155 (FIG. 1) one spin during the game 440, as the user associated with the friend B owns $1 in chips 425, as shown in FIG. 13. The user 155 (FIG. 1) may then invoke the play button 450.

Screen 10 shows another screen of the gaming screen 412, after the user 155 (FIG. 1) has invoked the play button 450. The gaming application 115 (FIG. 1) starts a spin of the game 440. As the friend B is the only stake item the user 155 (FIG. 1) placed into the wager area 432, it is taken out 483 of the wager area 432 and placed into the collection tray 434 with the status changed to lost. Contrary to the list of friends 420 (FIG. 4), where each friend is shown with either active or lost status throughout the gaming application 115 (FIG. 1), the chips 425 (FIG. 4) do not have a status and lost chips 425 are removed from the game 440, as shown in screen 4.

Screen 11 shows a screen of the gaming screen 412, after the virtual wheels 442 have stopped spinning and symbols 446 appear on the pay line 444. In one example, three of the same symbols 446 appear on the pay line 444 and the user 155 (FIG. 1) wins $5 in chips 425, according to the pay table 416 (FIG. 4). Then the prize of $5 is deposited in the collection tray 434 and the collect button 452 appears.

Screen 12 shows a screen of the gaming screen 412, which depicts the final status of the items shown in the wager area 432 and the collection tray 434, after the outcome of the previous spin has been processed. In one example, the wager area 432 contains no further stake items, and the collection tray 434 shows the status of the friend B as lost, and further shows that the user 155 (FIG. 1) has won $5 in chips 425.

Because the wager area 432 contains no stake items, the user 155 (FIG. 1) has no further options except for ending the game 440 by invoking the collect button 452, according to the program logic, as shown in FIGS. 14 and 15.

Screen 13 and screen 14 show two consecutive screens of the gaming screen 412, where the user 155 (FIG. 1) invokes the collect button 452, as shown in screen 13. The game 440 is ended and the repository 430 is updated 488, before the main screen 410 is displayed again, as shown in screen 14. During the update of the repository 430, the status of the friend B, which has been lost during the previous game 440, is updated in the repository 430. Further, the prize of $5 in chips 425 is added to the repository 430. In screen 14, the user 155 (FIG. 1) owns a total amount of $7 in chips 425 and has eight friends A through H, where all friends 420 have the status “active”, except for the friends B and C, which have the status “lost”.

Again, the list of friends 420 and the chips 425 in the repository 430 is persisted to the distributed database 130 (FIG. 1), after the repository 430 has been updated.

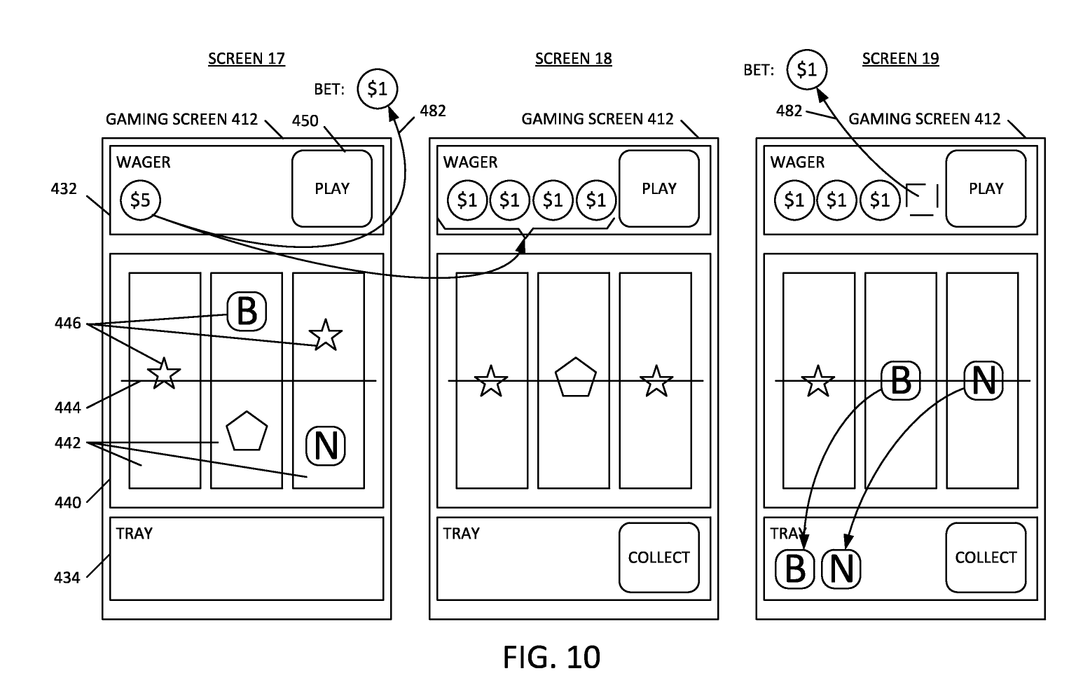

Screen 15 and screen 16 show two screens of the main screen 410, where the user 155 (FIG. 1) bets $5 by moving 480 one of the chips 425 into the wager area 432 to begin a new game 440 (FIG. 10), as shown in screen 17.

Screen 17 and screen 18 show two screens of the gaming screen 412, where the user 155 (FIG. 1) invokes the play button 450 to start the first spin of the game 440. The $5 chip of chips 425 (FIG. 4) is split into five pieces of $1 chips, and the value of $1 is taken out 482 of the wager area 432 as bet, while a value of $4 in chips 425 (FIG. 4) remains in the wager area 432.

As with real money, chips 425 (FIG. 4) of different denominations may be used interchangeably, as long as the total value of chips 425 (FIG. 4) is not changed during the conversion. A plurality of chips of smaller denominations may be converted into one single chip of a larger denomination, and a single chip of a larger denomination may be converted into a plurality of chips of a smaller denomination. As shown in one example, a $5 chip may be converted into five $1 chips, and vice versa. Further, as a friend may have a value of more than $1, according to FIG. 13, the friend may be converted into a plurality of chips 425 of equal value, before the spin starts.

Conversion rules between chips 425 (FIG. 4) and friends from the list of friends 420 (FIG. 4) may take many forms, such as for example, fixed and variable value conversions, different exchange rates for conversions in different directions, limitations on convertibility, etc.

As shown in screen 18, after the spin of the game 440 ends and the virtual wheels 442 stop spinning, no valid combination of symbols 446, according to the pay table 416 (FIG. 4), appears on the pay line 444. The user 155 (FIG. 1) wins nothing, despite of losing the $1 bet, and the user 155 (FIG. 1) invokes the play button 450 a second time, as shown in screen 19.

Screen 19 shows a screen of the gaming screen 412, where the virtual wheels 442 start and stop spinning, after the user 155 (FIG. 1) invokes the play button 450. The intermediate screen, where the virtual wheels 442 are spinning, is omitted, and the outcome of the spin is shown, after the bet has been taken out 482 of the wager area 432. In one example, the friend B and the friend N appear on the pay line 444 and the user 155 (FIG. 1) wins both friends (FIG. 4) during the spin, which are added to the list of friends 420 when the game ends. Again, the prize is placed into the collection tray 434. As shown in one example, the user 155 (FIG. 1) may reclaim a friend during a spin of the game 440, such as shown for the friend B, and the user 155 (FIG. 1) may win a new friend during a spin of the game 440, such as shown for the friend N. The user may also win or lose multiple friends during one spin of the game 440.

In one example, the user 155 (FIG. 1) may win additional users as friends, which are not part of the third-party social network 105 (FIG. 1) of the user 155 (FIG. 1), such as the friend N. As determined by the distributed business logic rules 125 (FIG. 1) based on factors such as, but not limited to, age, gender, geographic location, relationship or activity of each of user 155 (FIG. 1), users who are also subscribed to the gaming application 115 (FIG. 1) but who are not part of the user's third party social network 105 (FIG. 1) may be won as the outcome of a spin in the game 440.

In another example, the user may further win at least one of, but not limited to, virtual coins, money, chips, tokens or shopping coupons.

Screen 20 shows a screen of the gaming screen 412, which depicts the final status of items in the wager area 432 and the collection tray 434, after the outcome of the game 440 has been processed. In one example, chips 425 (FIG. 4) of a total value of $3 remain in the wager area 432, and the collection tray 434 shows the status of the friend B as won and indicates that the user 155 (FIG. 1) has won the friend N as a new friend, which is shown on the list of friends 420 (FIG. 4).

As the wager area 432 contains further stake items, the user 155 (FIG. 1) has the options of either invoking the play button 450 another time, as to start another spin and keep playing game 440, or to invoke the collect button 452, as to collect the items from both, the wager area 432 and the collection tray 434.

Screen 21 and screen 22 show two consecutive screens, where the user 155 (FIG. 1) invokes the collect button 452 in gaming screen 412, as shown in screen 21. The game 440 is ended and the repository 430 is updated 488, before the main screen 410 is displayed again, as shown in screen 22. During the update of the repository 430, the status of the friend B, which has been reclaimed during the previous game 440, is updated to active in the repository 430. Further, the new friend N is added to the repository 430. In screen 22, the user 155 (FIG. 1) owns a total amount of $5 in chips 425 (FIG. 4) and has nine friends A through H, and N, where all friends are active, except for the friends C, which appears as lost.

Again, the list of friends 420 (FIG. 4) and the chips 425 (FIG. 4) in the repository 430 is persisted to the distributed database 130 (FIG. 1), after the repository 430 has been updated. Even though the friend N is not a friend of the user 155 (FIG. 1) in the third-party social network 105 (FIG. 1), the friend N remains in the repository 430 of the user 155 (FIG. 1) and can be utilized by the user 155 (FIG. 1) as bet item during further games, similar to friends from the third-party social network 105 (FIG. 1). If the user 155 (FIG. 1) loses the friend N during a future game 440, the status of the friend N is shown as lost, but the friend N is not removed from the repository 430 of the user 155 (FIG. 1).

In one example, the screens, such as for example the main screen 410 (FIG. 4) and the gaming screen 412 (FIG. 5), may be combined into a single screen, and the wager area 432 (FIG. 4) only exists once on the single screen.

In another example, the repository 430 (FIG. 4) may show additional items, such as, but not limited to, shopping coupons, and the user 155 (FIG. 1) may win the additional items during the game 440 (FIG. 5).

In a further example, a friend from the list of friends 420 (FIG. 4) may be tagged with a plurality of colors, icons, or labels, and there may be more states which represent each friend in the gaming application 115 (FIG. 1) than just active and lost.

In another example, a friend from the list of friends 420 (FIG. 4) with the status “lost” may not be shown in the repository 340 (FIG. 4) at all.

In a further example, a copy of each friend from the third-party social network 105 (FIG. 1) may be stored in the distributed database 130 (FIG. 1). In various examples, the distributed database 130 (FIG. 1) may contain either of, but not limited to, cached data from the third-party social network 105 (FIG. 1), a reference link between the same friend in the gaming application 115 (FIG. 1) and in the third-party social network 105 (FIG. 1), the current status whether the friend from the list of friends 420 (FIG. 4) is an active friend or a lost friend, and other.

In one example, a friend from the third-party social network 105 (FIG. 1) may be added to or removed from the list of friends 420 (FIG. 4) or the database 130 (FIG. 1), as the friend is added to or removed from the third-party social network 105 (FIG. 1), respectively. In another example, a friend from the list of friends 420 (FIG. 4) stays friends in the gaming application 115 (FIG. 1), even when the friend is no longer a friend in the third-party social network 105 (FIG. 1).

In one further example, a friend from the list of friends 420 (FIG. 4) who is lost during the game 440 (FIG. 5) may never be reclaimed by the user 155 (FIG. 1) during the game 440 (FIG. 5), or the distributed business logic rules 125 of the gaming application 115 (FIG. 1) may provide other means for reclaiming lost friends. For example, the user 155 (FIG. 1) may re-purchase a plurality of lost friends with at least one of, but not limited to, virtual coins, money, chips, tokens or shopping coupons.

In another example, a friend from the list of friends 420 (FIG. 4) which has been selected as stake item and moved into the wager area 432 (FIG. 4) may be at least one of active friend and lost friend, and the user 155 (FIG. 1) may reclaim a at least one of lost friend by placing at least one of lost friend into the wager area 432.

In a further example, a different method may be used for selecting a friend from the list of friends 420 (FIG. 4) as bet item, such as, but not limited to, clicking or tapping the friend, and selected friend may be shown visually distinct, such as for example in a different color or with an overlay image, and no wager area 432 (FIG. 4) may be used. The selection of friends may take many forms, such as, but not limited to, clicking, tagging or tapping friends, or by dragging friends onto the play button 450 (FIG. 4) or into the wager area 432 (FIG. 4).

In one further example, the wager area 432 (FIG. 5) and the collection tray 434 (FIG. 5) may be consolidated into one single screen element of gaming screen 412 (FIG. 5).

In one example, the game 440 (FIG. 5) may have different or further rules. For example, the game 440 (FIG. 5) may include further items to bet or win, such as, but not limited to, money, virtual coins, chips, tokens or shopping coupons. A friend from the list of friends 420 (FIG. 4) may be used in conjunction with the further items, or one further item may be exchanged for or converted into another further item, for example, the user 155 (FIG. 1) may bet a friend from the list of friends 420 to win shopping coupons.

In one further example, the game 440 (FIG. 5) may include further forms of credits for playing the game 440 (FIG. 5), such as for example a counter for free plays or a bonus counter, which shows credits being used only while the game 440 (FIG. 5) lasts, and which are lost when the collect button 452 (FIG. 5) is invoked.

In another example, a friend from the list of friends 420 (FIG. 4) may be utilized by the user 155 (FIG. 1) for buying gaming credit, which is then used during the game 440 (FIG. 5).

In another example, users from a plurality of third-party social network 105 (FIG. 1) may be used as friends in the gaming application 115 (FIG. 1).

In a further example, a friend from the list of friends 420 (FIG. 4) may be added to or removed from the wager area 432 (FIG. 4) during the game 440 (FIG. 5) while the user 155 (FIG. 1) is playing or between spins, and without ending the game 440 (FIG. 5).

In one further example, the user 155 (FIG. 1) may influence the outcome of the game 440 (FIG. 5) by invoking at least one stop button to stop the virtual wheels 442 (FIG. 5) from spinning, before the timeout occurs and the wheels are stopped by the gaming application 115 (FIG. 1).

In another example, a symbol of the symbols 446 (FIG. 5) may appear anywhere within the visible gaming area of the game 440 (FIG. 5) and the user may win or lose, even if the symbol is shown off the pay line 444 (FIG. 5).

In a further example, the user 155 (FIG. 1) may bet a combination of at least one of active friends, lost friends, virtual coins, chips, tokens and shopping coupons, and the user 155 (FIG. 1) may win or lose a plurality of these items.

In one example, upon synchronization, a friend which has been newly added to the third-party social network 105 (FIG. 1) is also added to the repository 430 (FIG. 4) of the gaming application 115 (FIG. 1), but a friend which has been removed from the third-party social network 105 (FIG. 1) is not removed from the gaming application 115 (FIG. 1), even when the friend no longer exists in the third-party social network 105 (FIG. 1).

### Token or Chip

FIG. 12 illustrates how a friend 422 from the list of friends 420 (FIG. 4) may be visualized in different colors in the gaming application 115 (FIG. 1), according to one example. Often, chips 425 of different face value are represented in different colors. In one example, as shown in a color table 1220, chips 425 with a face value of $1 may be represented in green, chips 425 with a face value of $2 may be represented in yellow, chips 425 with a face value of $5 may be represented in red, and chips 425 (FIG. 4) with a face value of $10 may be represented in blue.

Often, in applications, a profile photo is shown to visualize a user 155 (FIG. 1) as friend on the list of friends 420 (FIG. 4), for example as friends are shown in the Facebook social network. In the drawings of this invention, the profile photo has been replaced with a box with rounded edges and a capital letter A through H, N or U in the center of the box, as to better be able to differentiate each distinct friend on the list of friends 420. In one example, each friend from the list of friends 420 may be visualized utilizing a profile photo from the third-party social network 105 (FIG. 1), surrounded by a color ring 1210, where the color ring 1210 has the same color as a chip of the chips 425, and where the value of the chip is of equal value as the value of the friend, according to the color table 1220, and where the value of the friend is calculated by adding all chips 425 of the user which the friend represents, as explained in FIG. 13.

If no exact matching value exists between a friend from the list of friends 420 and a chip from the chips 425, according to the color table 1220, the next available smaller chip value determines the color of the color ring 1210 for the friend. For example, the friend B and the friend C from the list of friends 420 may be shown with a green color ring 1210, because the user 155 (FIG. 1) which the friend represents has a sum of $1 in chips 425 in the repository 430 (FIG. 13), and the friend U may be shown with a red color ring 1210, because the user 155 (FIG. 1) which the friend represents possesses a sum of $6 in chips 425 in the repository 430 (FIG. 13), and the $5 chip is the next smaller available denomination of chips 425, according to the color table 1220.

It is clear that only certain denominations of certain values of chips 425 may exist, such as $1, $2, $5 and $10, but the value of a friend may be any value, even if such value is between two of the available denominations of chips 425, such as for example $3 or $7. If the value of a friend surpasses one of the available denominations of chips 425, but does not reach another available denomination of chips 425, the color ring 1210 is shown in the color of the next lower available denomination of chips 425 for the friend. For example, if the value of a friend is $3, the color ring is shown in yellow, corresponding to the $2 chip, and if the value of the friend is $7, the color ring is shown in red, corresponding to the $5 chip.

In one example, a color ring 1210 may be used to demonstrate the value of a friend from the list of friends 420, in another example, a different graphical representation is used to show the value of friends, such as, but not limited to, a square, a line, a dot or an overlay.

Friends Playing with Each Other

FIG. 13 shows three screens of distinct users 155 who employ the gaming application 115, as shown in FIG. 1, and where the distinct users 155 are friends in the third-party social network 105 (FIG. 1). In FIG. 13, each individual user 155 is illustrated as a box without rounded edges and a capital letter B, C or U in the center of the box. As can be seen, each user 155 is represented to the other users 155 as a friend on the list of friends 420 in the repository 430 on the main screen 410. For example, the user B may be shown as friend B in the repository 430 on the screen of user C, and the user C may be shown as friend C in the repository 430 on the screen of user B, as the user B and the user C are friends in the third-party social network 105 (FIG. 1). Further, both, the user C and the user U, may be shown in the repository 430 as friends on the screen of user B, as the user B is friend with both, the user C and the user U, in the third-party social network 105 (FIG. 1). Although the user C and the user U are also friends in the third-party social network 105 (FIG. 1) in this example, this is not a requirement for the friend C and the friend U to be shown in the repository 430 on the screen of user B.

In one example, friendship may be bilateral, such as for example, the user B may be a friend of the user C, and at the same time the user C may be also a friend of the user B. In another example, friendship may be unilateral, and for example the user B is a friend of the user C, but the user C is not a friend of the user B. In a further example, friendship may be bilateral, but turns to unilateral friendship, when one of the users 155 loses a friend during the game 440 (FIG. 5).

As shown in the screen of user B, the screen of user C and the screen of user U, each of user 155 may have further friends in the third-party social network 105 (FIG. 1), such for example the friends E and X, which are shown on the list of friends 420 and in the repository 430 of the user B, in addition to the friends C and U.

In one example, as shown in FIG. 13, the user B is shown to other distinct users 155, such as the user C and the user U, as friend B with the color ring 1210 (FIG. 12) in green color, because the sum of the chips 425 in the repository 430 of the user B is $1, and the color code which corresponds to the $1 chip of the chips 425 is green, as shown in the color table 1220 (FIG. 12). Further, the user U is shown to other distinct users 155, such as the user B and the user C, as friend U with the color ring 1210 (FIG. 12) in red color, because the sum of the chips 425 in the repository 430 of the user U is $6, and the color code which corresponds to the next lower available denomination of the chips 425, the $5 chip of the chips 425, is red, as shown in the color table 1220 (FIG. 12).

### Program Logic Flow

FIGS. 14 and 15 display a flowchart showing the program logic employed when the user 155 (FIG. 1) invokes the gaming application 115 (FIG. 1). Those of ordinary skill in the art will appreciate that different or similar program logic is within the true scope and spirit of the present invention using different or similar terms and techniques. Program steps of the program logic are shown in FIGS. 14 and 15, such as for example program step 1415, program step 1420, program step 1435, and further program steps. As shown in FIG. 14, after the user 155 (FIG. 1) starts 1405 the gaming application 115 (FIG. 1) on the user device 150 (FIG. 1), the gaming application 115 (FIG. 1) may look up the user 155 (FIG. 1) in the distributed database 130 (FIG. 1) through use of the distributed business logic rules 125 (FIG. 1). If the gaming application 115 (FIG. 1) determines that the user 155 (FIG. 1) is not yet signed up 1410, the gaming application 115 (FIG. 1) may require the user 155 (FIG. 1) to sign up 1415 with the gaming application 115 (FIG. 1). The gaming application 115 (FIG. 1) may then store account information of the user 155 (FIG. 1) in the distributed database 130 (FIG. 1). In one example, as shown in the login screen 300 (FIG. 3), the user 155 (FIG. 1) may connect 1420 the gaming application 115 (FIG. 1) with the third-party social network 105 (FIG. 1) and authorize the gaming application 115 (FIG. 1) to retrieve social network friends 420 (FIG. 4) from the third-party social network 105 (FIG. 1) in the context of the user 155 (FIG. 1). In another example, the user 155 (FIG. 1) may sign up 1415 with the gaming application 115 (FIG. 1) first, for example by utilizing and validating an email address, and connect 1420 with the third-party social network 105 (FIG. 1) in a separate step. The gaming application 115 (FIG. 1) may then associate a unique identifier which identifies the user 155 (FIG. 1) in the third-party social network 105 (FIG. 1), as determined by the service development kit 120 (FIG. 1), with account information of the user 155 (FIG. 1) in the distributed database 130 (FIG. 1).

During sign up 1415, an empty repository 430 (FIG. 4) may be created in the distributed database 130 (FIG. 1) and associated with the account of the user 155 (FIG. 1) in the gaming application 115 (FIG. 1).

If the gaming application 115 (FIG. 1) determines that the user 155 (FIG. 1) is already signed up 1410, the user 155 (FIG. 1) may be signed into 1425 the gaming application 115 (FIG. 1) and the gaming application 115 (FIG. 1) may connect 1430 with the third-party social network 105 (FIG. 1). While, according to one example, sign in 1425 and connecting 1430 with the third-party social network 105 (FIG. 1) may be performed in a single step [single sign-on], in another example the steps 1425 and 1430 are performed sequentially.

After the gaming application 115 (FIG. 1) is connected with the third-party social network 105 (FIG. 1), the gaming application 115 (FIG. 1) may communicate with the third-party social network 105 (FIG. 1) through use of the service development kit 120 (FIG. 1), and retrieve 1435 the social network friends 420 (FIG. 4) of the user 155 (FIG. 1) from the third-party social network 105 (FIG. 1). The gaming application 115 (FIG. 1) may then synchronize 1435 friends between the list of friends 420 (FIG. 4) and the third-party social network 105 (FIG. 1), by adding new friends 420 (FIG. 4) to the distributed database 130 (FIG. 1) and by removing friends 420 (FIG. 4) from the distributed database 130 (FIG. 1), if these no longer exist on the third-party social network 105 (FIG. 1).

The gaming application 115 (FIG. 1) may then update changes in the distributed database 130 (FIG. 1) and show 1440 the main screen 410 (FIG. 4) with the updated repository 430 (FIG. 4), before the gaming application 115 (FIG. 1) may wait for user input 1445, where user 155 (FIG. 1) may select to bet a friend 1450, to play a game 1455, or to sign out 1460.

When the gaming application 115 (FIG. 1) requests for user input 1445, the user 155 (FIG. 1) may select to bet a friend 1450 by moving 1465 one active friend on the list of friends 420 (FIG. 1) from the repository 430 (FIG. 4) to the wager area 432 (FIG. 4), the active friend being then shown as selected in the wager area 432 (FIG. 4). The gaming application 115 (FIG. 1) may then update the changes in the distributed database 130 (FIG. 1) and show 1440 the main screen 410 (FIG. 4) again with the updated repository 430 (FIG. 4) and the updated wager area 432 (FIG. 4). The user 155 (FIG. 1) may select to bet a friend 1450 until no more of active friend is available in the repository 430 (FIG. 4). As can be seen, a friend from the list of friends 420 (FIG. 4) may either be shown as active friend or as lost friend. While a friend from the list of friends 420 (FIG. 4) is selected in the wager area 432 (FIG. 4), the friend is temporarily separated from the repository 430 (FIG. 4) until the game ends, as can be seen in screen 3 (FIG. 4).

If at least one of a selected friend is available for playing in the wager area 432 (FIG. 4), the user 155 (FIG. 1) may further select to play 1455 a game 1470, as shown in FIG. 15, when the gaming application 115 (FIG. 1) requests for user input 1445. As shown in FIG. 5, the user 155 (FIG. 1) may lose a selected friend as outcome of the game 440 (FIG. 5). If at least one of selected friend is lost 1475 as outcome of the game 440 (FIG. 5), the status of the selected friend is changed 1480 to lost friend and the selected friend is moved 1480 from the wager area 432 (FIG. 4) to the collection tray 434 (FIG. 5). If no further selected friend is present 1485 in the wager area 432 (FIG. 4), the game ends and the lost friends are returned 1490 to the repository 430 (FIG. 4) with the status lost, before the distributed database 130 (FIG. 1) is updated. If at least one of selected friend is still present in the wager area 432 (FIG. 4), the user 155 (FIG. 1) may select 1495 to play another game 1470.

If the user 155 (FIG. 1) selects 1495 not to play another game, all friends which have been utilized during the game 440 (FIG. 5) are returned 1490 to the repository 430 (FIG. 4), whereby lost friends, as found in the collection tray 440 (FIG. 4) are returned to the repository 430 (FIG. 4) as lost friend, and active friends, which still remain in wager area 432 (FIG. 4) are returned to the repository 430 (FIG. 4) as active friend.

Then the status of friends is updated in the distributed database 130 (FIG. 1), before the updated repository 430 (FIG. 4) is shown 1440 to the user 155 (FIG. 1) on main screen 410 (FIG. 4), and the gaming application 115 (FIG. 1) may again wait for user input 1445 of the user 155 (FIG. 1), as depicted in FIG. 14.

When the gaming application 115 (FIG. 1) requests for user input 1445, the user 155 (FIG. 1) may further select to sign out 1460, in which case the gaming application 115 (FIG. 1) may sign out 1498 the user 155 (FIG. 1) from the third-party social network 105 (FIG. 1) and from the gaming application 115 (FIG. 1), update the status of friends in the distributed database 130 (FIG. 1) and quit 1499 the user session.

In one example, the outcome of the game 440 (FIG. 5) depends either on skill or luck of the user 155 (FIG. 1), in another example the distributed business logic rules 125 (FIG. 1) determine the chances of the user 155 (FIG. 1).

In one example, the user 155 (FIG. 1) may interrupt the game 440 (FIG. 5) and select a further friend from the list of friends 420 (FIG. 4) to keep playing.

In one example, the gaming application 115 (FIG. 1) may provide additional means of credit apart from friends, and the user 155 (FIG. 1) may decide which sort of credit they put at risk. In another example, an additional means of credit may be a shopping coupon, which the user 155 (FIG. 1) may win during the game 440 (FIG. 5). The shopping coupon may be introduced into the distributed database 130 (FIG. 1) from an ad network such as, but not limited to, Google Adwords at online URL (http://adwords.google.com) the teachings of which is hereby incorporated by reference in its entirety. The shopping coupon may be utilized during the game 440 (FIG. 5) in the same or a similar way as a friend from the list of friends 420 (FIG. 4) or a chip of the chips 425 (FIG. 4).

In one further example, the gaming application 115 (FIG. 1) may not sign out the user 155 (FIG. 1) from the third-party social network 105 (FIG. 1) and the third-party social network 105 (FIG. 1) disconnects from the gaming application 115 (FIG. 1) after a timeout as determined by the third-party social network 105 (FIG. 1).

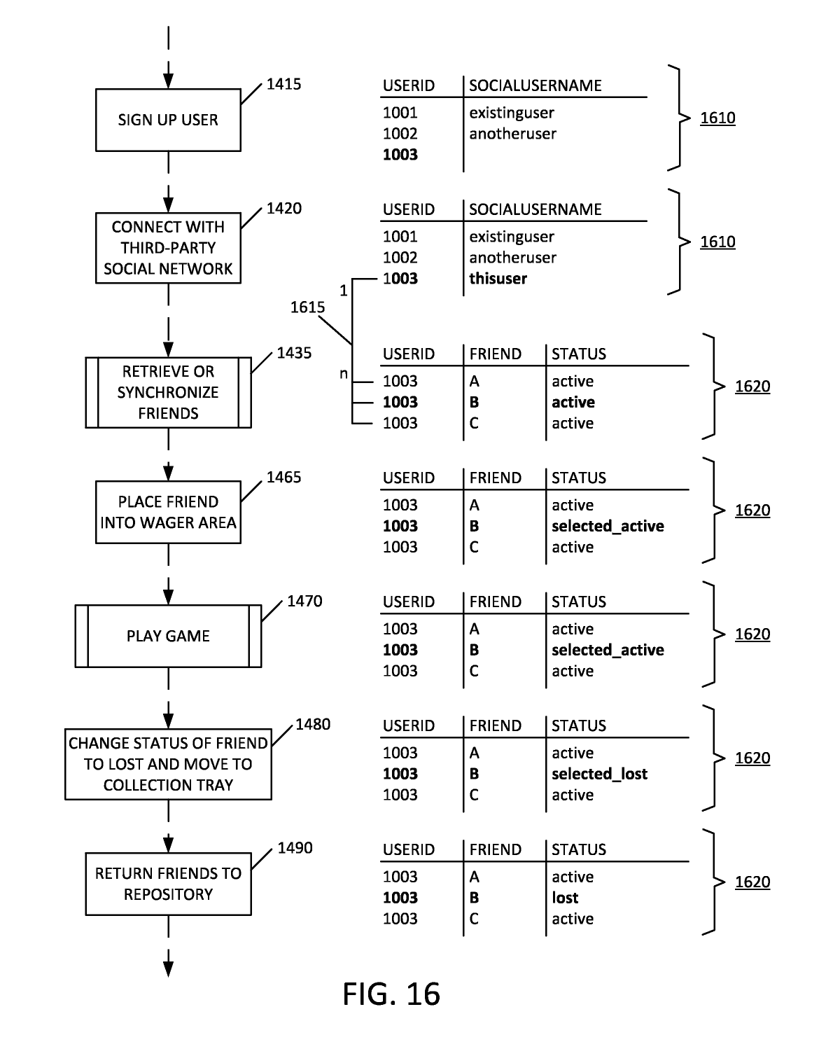

FIG. 16, according to one example, is showing tables from the distributed database 130 (FIG. 1), such as a user table 1610 and a friends table 1620, illustrating how database records change when the program logic is employed. When a program step of the program steps 1415 through 1490 (FIGS. 14 and 15) is employed, records in the tables are inserted, modified or deleted.

In the example, the program step 1415 is shown. The user 155 (FIG. 1) may sign up with the gaming application 115 (FIG. 1). A new unique USERID “1003” is created in the user table 1610. Based upon the user 155 (FIG. 1) connecting with the third-party social network 105 (FIG. 1), as shown in the program step 1420, the SOCIALUSERNAME “thisuser” is associated with the new unique USERID “1003” and persisted in the user table 1610 as a new row. While only two columns USERID and SOCIALUSERNAME are shown, the user table 1610 may contain further columns.

When the user 155 (FIG. 1) signs up with the gaming application 115 (FIG. 1), as shown in the example, friends of the user 155 (FIG. 1) are retrieved from the third-party social network 105 (FIG. 1). During the program step 1435, a new row is inserted into the friends table 1620 for each friend in the third-party social network 105 (FIG. 1). The new row is associated with the USERID “1003” of the user 155 (FIG. 1). While a one-to-many relationship 1615 is shown as to associate a record from the user table 1610 with multiple records from the friends table 1620, as often used in SQL (“structured query language”) databases, it is important to note that other relationships and/or database types may be used. Further, while only three columns USERID, FRIEND and STATUS are shown, the friends table 1620 may contain further columns. Moreover, the column FRIEND of the friends table 1620 has been named “FRIEND” as to better understand FIG. 16 in the context of this invention, but those of ordinary skill in the art will appreciate that the FRIEND column may contain user names of friends from the third-party social network 105 (FIG. 1) and may therefore be named SOCIALUSERNAME instead, as friends from the third-party social network 105 (FIG. 1) customarily have unique user names in the third-party social network 105 (FIG. 1), which merely have been replaced with the capital letters A through H, N and U in the list of friends 420 in this invention.

In one example, friends are retrieved from the third-party social network 105 (FIG. 1) during the program step 1435. Records are inserted into the friends table 1620 and the STATUS is set as “active” for the newly inserted records. In another example, the friends table 1620 already contains records of friends from the third-party social network 105 (FIG. 1) for the user 155 (FIG. 1). The existing records are synchronized with the friends from the third-party social network 105 (FIG. 1), where the STATUS is only set to “active” for records which are inserted into the friends table 1620 during the synchronization.

According to one example, a friend B is retrieved from the third-party social network 105 (FIG. 1) during the program step 1435 and the STATUS column of the friends table 1620 is set to “active” for the friend B. When the user 155 (FIG. 1) decides to wager the friend B during the program step 1465 by moving the friend B into the wager area 432 (FIG. 4), the STATUS of the friend B is changed to “selected_active” in the friends table 1620. As can be seen, there are four possible statuses for a friend: If a friend has the status “active” or “lost” in the friends table 1620 of the distributed database 130 (FIG. 1), the friend appears in the repository 430 (FIG. 4) in the gaming application 115 (FIG. 1) as active friend or lost friend, respectively. If a friend is selected into the wager area 432 (FIG. 1) by the user 155 (FIG. 1) and used during the game 440 (FIG. 5), the friend no longer appears in the repository 432 (FIG. 4). A selected friend may be active or lost, and the status of the friend is changed to “selected_active” or “selected_lost”, respectively. A selected friend is active, while the friend has not been lost as outcome of the game 440 (FIG. 5). A friend with the status “selected_active” is shown in the wager area 432 (FIG. 4), while a friend with the status “selected_lost” is shown in the collection tray 434 (FIG. 5).

While the program step 1470 is performed, the STATUS of the friend B is “selected_active” until the friend B is lost during the game 440 (FIG. 5), when the STATUS changes to “selected_lost” and the friend B is shown as lost friend in the collection tray 434 (FIG. 5), as shown in program step 1480. Finally, in the program step 1490, the game 440 (FIG. 5) ends. The friend B is returned to the repository 430 (FIG. 4). Then, the STATUS of the friend B is changed to “lost” in the friends table 1620 of the distributed database 130 (FIG. 1).

### Non-Limiting Examples

As will be appreciated by one skilled in the art, aspects of the present invention may be embodied as a system, method, or computer program product. Accordingly, aspects of the present invention may take the form of an entirely hardware example, an entirely software example (including firmware, resident software, micro-code, etc.) or an example combining software and hardware aspects that may all generally be referred to herein as a “circuit”,” “module”, or “system.” Furthermore, aspects of the present invention may take the form of a computer program product embodied in one or more than one of computer readable medium(s) having computer readable program code embodied thereon.

Any combination of one or more than one of computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more than one of wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable storage product or computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more than one of programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been discussed above with reference to flowchart illustrations and/or block diagrams of methods, apparatus (systems), and computer program products according to various examples of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium or computer readable storage medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The terminology used herein is for the purpose of describing particular examples only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more than one of other features, integers, steps, operations, elements, components, and/or groups thereof.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The example was chosen and described in order to best explain the principles of the invention and the practical application, and to enable others of ordinary skill in the art to understand the invention for various examples with various modifications as are suited to the particular use contemplated.

What is claimed is:

1. A method of performing a game on an electronic device, the method comprising:
operating at least one electronic game;
accessing a list of one or more friends, each of the friends in the list of friends representing a value;
placing a wager for the electronic game using at least one friend from the list of friends,
participating in at least one turn at the electronic game with the wager; and
based on
a winning outcome of the electronic game, the at least one friend stays on the list of friends, and
a losing outcome of the electronic game, the at least one friend is removed from the list of friends.

2. The method of claim 1, wherein based on the winning outcome of the electronic game, at least one of a virtual coin, credit, cash, a chip, a token or a coupon is won.

3. The method of claim 1, wherein based on the losing outcome of the electronic game, at least one of a virtual coin, credit, cash, a chip, a token or a coupon is lost.

4. The method of claim 1, wherein the accessing a list of one or more friends includes accessing a list of friends from a third-party social network.

5. The method of claim 1, wherein based upon a winning outcome of the electronic game, a new friend from a third-party social network is added to the list of friends.

6. The method of claim 5, wherein based upon a winning outcome of the electronic game, a new friend that was previously removed from the list of friends is re-added to the list of friends.

7. The method of claim 5, wherein based upon a winning outcome of the electronic game, a new friend network is added to the list of friends, the new friend selected based on an association of at least one of
an age of the new friend,
a geographic location of the new friend,
a gender of the new friend,
an interest of the new friend, and
a relationship with the new friend.

8. The method of claim 1, wherein the value of each friend of the list of friends is selected from a set of at least two distinct values.

9. The method of claim 8, further comprises:
representing a friend from the list of friends with a token, the token includes at least one of a color code, an icon, and a label, according to the value of each friend on the list of friends.

10. The method of claim 1, wherein the electronic game is one of cards, roulette, bingo, slot, pachinko, dice and lottery.

11. The method of claim 1, wherein the placing a wager includes using a token representing a friend from the list of friends.

12. The method of claim 11, wherein the token representing a friend from the list of friends includes a picture of the friend.

13. The method of claim 12, wherein the picture of the friend is retrieved from a third-party social network.

14. The method of claim 1, further comprising:
exchanging at least one of the friends from the list of friends for at least one of a virtual coin, credit, cash, a chip, a token or a coupon.

15. A non-transitory computer readable storage medium for performing a game on an electronic device, the computer readable storage medium comprising instructions configured to perform a method comprising:
operating at least one electronic game;
accessing a list of one or more friends, each of the friends in the list of friends representing a value;
placing a wager for the electronic game using at least one friend from the list of friends,
participating in at least one turn at the electronic game with the wager; and
based on at least one of
a winning outcome of the electronic game, the at least one friend stays on the list of friends, and
a losing outcome of the electronic game, the at least one friend is removed from the list of friends.

16. The non-transitory computer readable storage medium of claim 15, wherein based on the winning outcome of the electronic game, at least one of a virtual coin, credit, cash, a chip, a token or a coupon is won.

17. The non-transitory computer readable storage medium of claim 15, wherein based on the losing winning outcome of the electronic game, at least one of a virtual coin, credit, cash, a chip, a token or a coupon is lost.

18. The non-transitory computer readable storage medium of claim 15, wherein the accessing a list of one or more friends includes accessing a list of friends from a third-party social network.

19. A system for performing a game on an electronic device, the system comprising:
a memory;
a processor communicatively coupled to the memory, where the processor is configured to perform
operating at least one electronic game;
accessing a list of one or more friends, each of the friends in the list of friends representing a value;
placing a wager for the electronic game using at least one friend from the list of friends, participating in at least one turn at the electronic game with the wager; and
based on at least one of
a winning outcome of the electronic game, the at least one friend stays on the list of friends, and
a losing outcome of the electronic game, the at least one friend is removed from the list of friends.

20. The system of claim 19, wherein based on the winning outcome of the electronic game, at least one of a virtual coin, credit, cash, a chip, a token or a coupon is won.
